(19) United States
(12) Patent Application Publication
(10) Pub. No.: US 2013/0144975 A1
(43) Pub. Date: Jun. 6, 2013

(54) IMAGE INFORMATION PROCESSING APPARATUS AND IMAGE INFORMATION PROCESSING METHOD

(71) Applicant: Seiji MIYAHARA, Kanagawa (JP)

(72) Inventor: Seiji MIYAHARA, Kanagawa (JP)

(21) Appl. No.: 13/693,286

(22) Filed: Dec. 4, 2012

(30) Foreign Application Priority Data
Dec. 5, 2011 (JP) 2011-265769

(51) Int. Cl. H04L 29/08

(52) U.S. Cl. CPC H04L 67/306
USPC 709/217

(57) ABSTRACT

An image information processing apparatus which processes image information to be provided to user terminals via a communication network includes a user information obtaining section obtaining user information from the information sent from the user terminals, and an image correcting section attaching a selected profile based on the user information to the image information to be sent to the user terminals capable of processing the profile, correcting colors according to the profile for the user terminals incapable of processing the profile before sending the image information to the user terminals.

### BACKGROUND OF THE INVENTION

1. Field of the Invention

The disclosures herein generally relate to image information processing apparatuses and image information processing methods for viewing images such as photographs via the Internet.

2. Description of the Related Art

Services have been provided with which a user may access web servers connected to the Internet to view images such as photographs on the user's terminal, or the user may disclose images publicly from the user's terminal to the web servers to be stored in image databases.

FIG. 8 is a block configuration diagram of a system providing these image-related services. User terminals 101-104 and a web server 200 are connected to the Internet 100. An image database 201 storing image data is connected to the web server 200. Although not shown in FIG. 8, each user terminal is connected to the Internet via an access point and the like located in a local region including the location of the user terminal. In this example, an image provider A using the user terminal 101 provides images such as photographs, and viewers B1-B3 view the provided images at their user terminals 102-104. The user terminal 101 that provides the images may be, for example, a personal computer with image displaying function, a mobile terminal such as a cellphone with camera function, a digital still camera connectable to a network, and the like. The web server 200 provides a user interface to the user terminals 102-104. The user interface is used for searching for images stored in the image database 201. The web server 200 also reads images from the image database 201 in response to requests from the user terminals 102-104, and sends the images back to the user terminals 102-104. In addition, the web server 200 stores images provided by the user terminal 101 into the image database 201.

For these services providing image information, it is required to display images correctly at user terminals when the services are provided to a large indefinite number of users viewing or buying the images. To display images correctly, service providers may have asked users to input the users' personal information such as residential regions, then, corrected the image information according to the regionality based on the obtained personal information before providing the images to the users. A user might hesitate, however, to input the user's personal information when the user has not yet decided to buy images from the viewpoint of security, when accessing a large number of images stored in the image database. This type of user may access other services requiring no input of personal information, with which the users may be forced to view images not correctly displayed. This problem may prevent image information providing services from becoming popular.

Therefore, techniques for distributing information which do not rely on inputs of user information have been put to practical use. The techniques may take the regionality of a user into account by identifying the user's residential region based on an IP address of the user's terminal accessing to the Internet, without requiring the user's personal information. For example, Japanese Patent No. 3254422 discloses a method for providing web information. The method uses a regional database which includes correspondences between an IP address of an access point assigned to a user terminal and a region where the access point is located. By referring to the region database, the method can identify the region that corresponds to the access point to which the user terminal is connected, from the IP address assigned to the user terminal. Based on the identified region, the method selects the web information corresponding to the region to send to the user terminal. Japanese Laid-open Patent Publication No. 11-338662 disclosed a printing device which holds data for color correction, and is connected to a personal computer. The data for color correction is sent to a browser on the personal computer as a Hyper Text Markup Language (HTML) document. Input information on the personal computer is to be corrected based on the HTML document when it is printed.

As disclosed in Japanese Laid-open Patent Publication No. 11-338662, a color tone of an image may vary when displayed depending on an operating system (OS) installed on a personal computer or related programs such as a web browser. When displaying an image on a user terminal, color correction is needed according to programs installed on the terminal to display the image correctly. Although a method disclosed in Japanese Patent No. 3254422 sends the web information corresponding to the region to the user terminal based on the IP address assigned to the user terminal, the method does not take programs installed on the user terminal into account when dealing with services providing image information. Therefore, the method cannot display images including photographs with correct colors. The image may be displayed with artificially vivid colors, or to the contrary, low saturation colors.

### SUMMARY OF THE INVENTION

It is a general object of at least one embodiment of the present invention to provide an image information processing apparatus and an image information processing method that substantially obviate one or more problems caused by the limitations and disadvantages of the related art.

Specifically, in one embodiment, image information provided to a user terminal via the Internet is displayed with proper colors according to the user terminal.

According to an embodiment, an image information processing apparatus which processes image information to be provided to user terminals via a communication network includes a user information obtaining section to obtain user information from the user terminals, and an image correcting section to attach a selected profile based on the user information to the image information to be sent to the user terminals capable of processing the profile, and to correct colors of the image information according to the profile for the user terminals incapable of processing the profile before sending the image information to the user terminals.

### BRIEF DESCRIPTION OF THE DRAWINGS

Other objects and further features of embodiments will be apparent from the following detailed description when read in conjunction with the accompanying drawings, in which:

FIG. 1 is a block configuration diagram illustrating an image information processing system including an image information processing apparatus;

FIG. 2 is a block diagram illustrating a hardware configuration of the image information processing apparatus;

FIG. 3 is a flowchart illustrating a procedure for providing image data;

FIG. 4 is a flowchart illustrating a procedure for obtaining user information;

FIG. 5 is another flowchart illustrating a procedure for obtaining user information;

FIG. 6 is a table illustrating correspondences between “HTTP_ACCEPT_LANGUAGE” data and languages;

FIGS. 7A-B are lists illustrating a profile; and

FIG. 8 is a block configuration diagram illustrating a conventional system providing image processing services.

### DESCRIPTION OF THE PREFERRED EMBODIMENTS

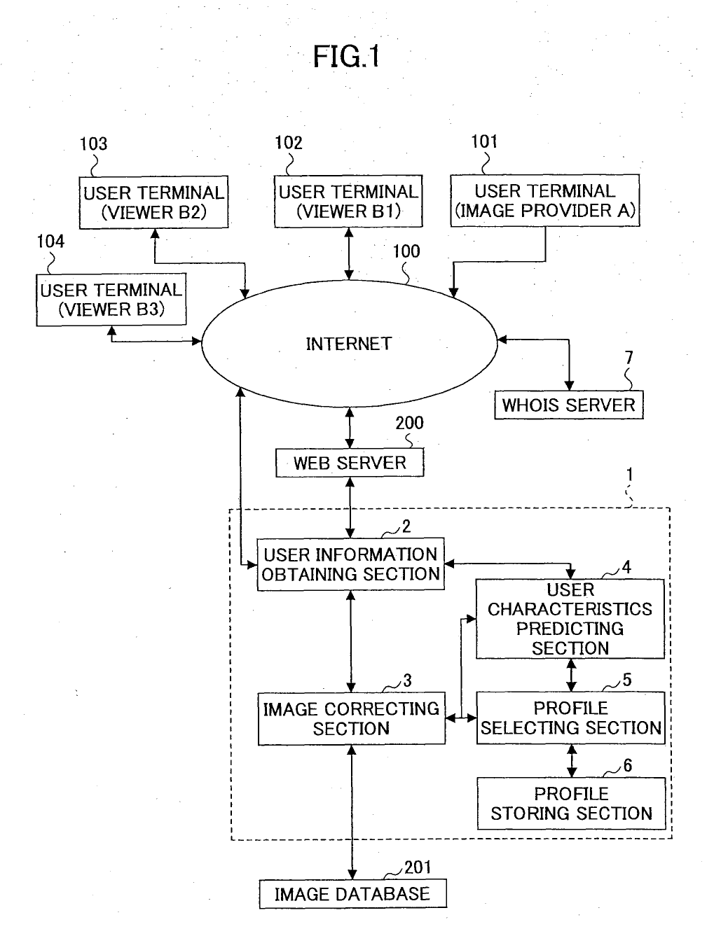

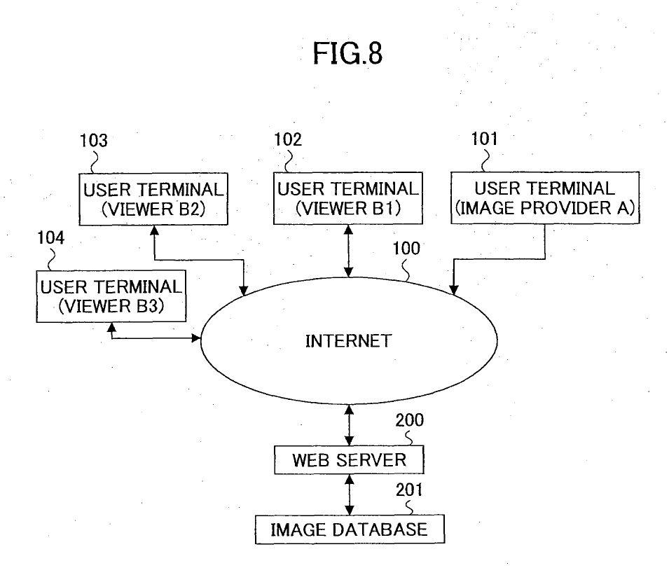

In the following, embodiments of the present invention will be described with reference to the accompanying drawings. FIG. 1 is a block configuration diagram illustrating an image information processing system including an image information processing apparatus 1. In FIG. 1, the Internet 100, the user terminals 101-104, the web server 200 and the image database 201 are the same as in FIG. 8, whose explanation is skipped here. The image information processing apparatus 1 provides a user information obtaining section 2, a image correcting section 3, a user characteristics predicting section 4, a profile selecting section 5, and a profile storing section 6. A Whois server 7, which is publicly known, is connected to the Internet 100. The Whois server 7 receives an IP address of a user terminal sent from the user information obtaining section 2, then sends administrative information corresponding to the IP address back to the user information obtaining section 2. It is noted that although the image information processing apparatus 1 is separated from the web server 200 in the example, the image information processing apparatus 1 may be integrated with the web server 200 and provided with the function of the web server 200.

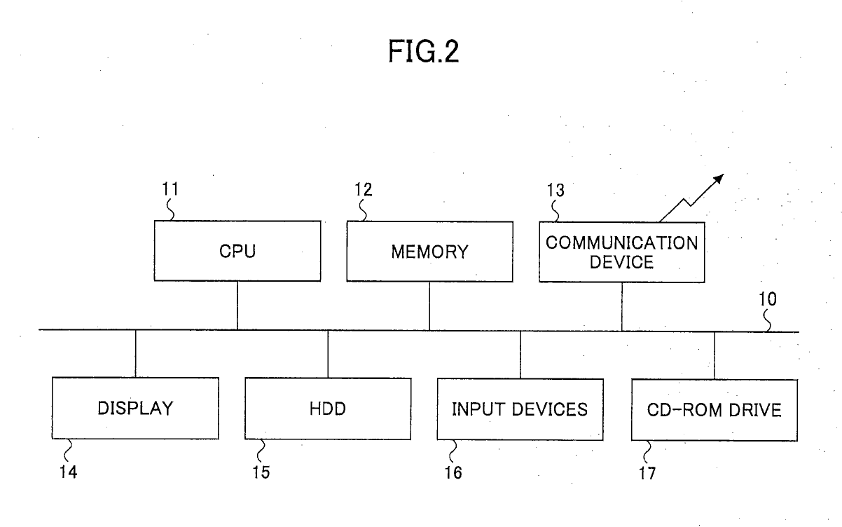

FIG. 2 is a block diagram illustrating a hardware configuration of the image information processing apparatus 1. The image information processing apparatus 1 provides a bus 10, to which a central processing unit (CPU) 11, a memory 12, a communication device 13, a display 14, a hard disk drive (HDD) 15, input devices 16, and a CD-ROM drive are connected. The CPU 11 controls the image information processing apparatus 1. The memory 12 includes a ROM which stores start-up programs and associated data run by the CPU 11, and a RAM which is used as a work area of the CPU 11. Using the RAM as the work area, the CPU 11 has software programs stored in the ROM or the HDD 15 run so that the CPU functions as a control section of the computer including the above elements. The computer in the present embodiment implements functions of the above sections by running programs for sending image information to user terminals.

The communication device 13 is connected to the web server 200 and the image database 201 to send or receive data. In case that the image information processing apparatus 1 is integrated with the web server 200, the communication device 13 is a device connected to the Internet 100 to execute data communications between the user terminals 101-104 and the Whois server. The display 14 may include a liquid crystal panel display to display screens for operations and monitoring of the image information processing apparatus. The input devices 16 include a keyboard, a mouse and the like to input various key operations and commands to the image information processing apparatus 1.

The HDD 15 stores various application programs, work data, and file data. The CD-ROM drive 17 is a device for reading data from recording media such as CD-ROM, DVD-ROM and the like.

The user information obtaining section 2 obtains information from the web server 200, which may not be recognized by users explicitly. The information may include intervals of operations by users at the user terminals 101-104, IP addresses assigned to the user terminals 101-104, web browsers used at the user terminals 101-104, etc. The user information obtaining section 2 also sends IP addresses assigned to the user terminals 101-104 to the Whois server 7 to obtain administrative information corresponding to the IP addresses from the Whois server 7.

The image correcting section 3 obtains image data from the image database 201 requested by the web server 200, and processes the image data to be displayed with correct colors based on profile information sent from the profile selecting section 5. Specifically, the image correcting section 3 corrects colors of the image data based on the profile information, or attaches the profile information to the image data. The user characteristics predicting section 4 identifies an OS used at the user terminals, color management functions of web browsers, an age group of a user, etc., based on the user information obtained at the user information obtaining section 2. Based on the identified results, the user characteristics predicting section 4 generates user characteristics information to send to the profile selecting section 5. The profile selecting section 5 selects a profile from the profile storing section 6 which is used for color correction of the image data based on the user characteristics information sent from the user characteristics predicting section 4. The profile storing section 6 stores multiple profiles to display colors of the image data stored in the image database 201 properly according to characteristics or residence regions of users. The profiles reflect memory colors or preferred colors classified with various residential regions or age groups. The profiles are generated with subjective assessment experiments in advance.

A profile is data used for correcting output color differences appearing on different devices such as displays or printers. The profile is also a data file in which a method for reproducing colors on a specific device is mathematically described. The profile standardized by ICC (International Color Consortium) is publicly known. The profile has a role to convey color information correctly, for example, which standard the profile is compliant with. Therefore, it is possible to display with proper colors on a device by using a profile compatible with the device.

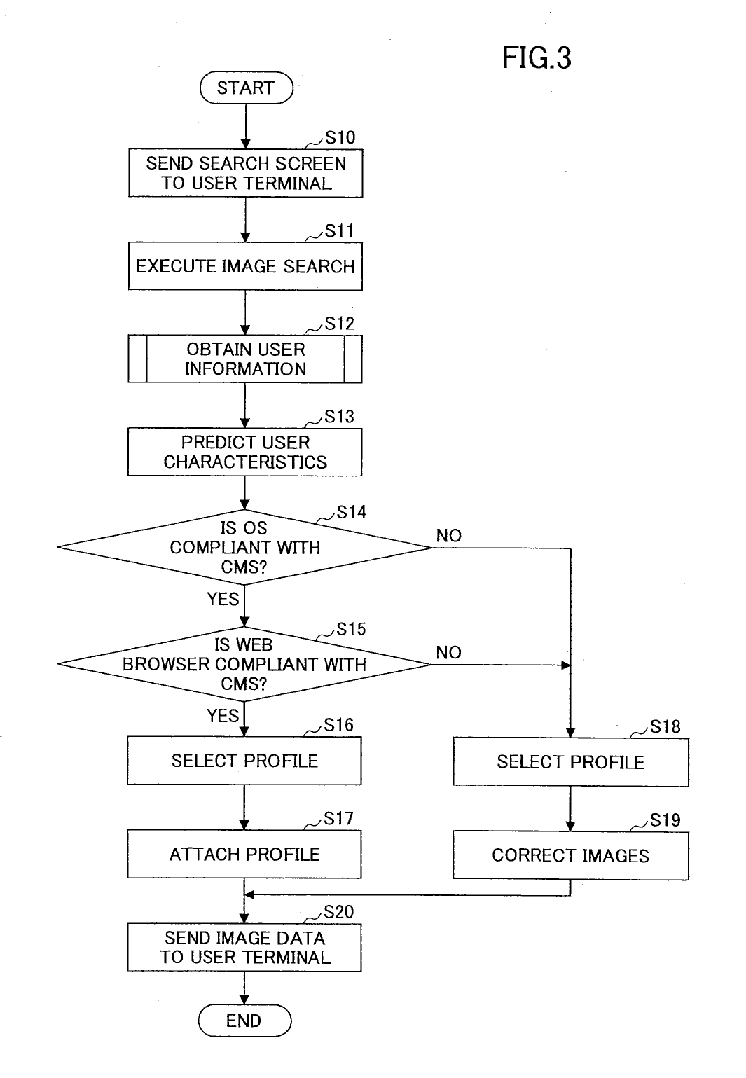

FIG. 3 is a flowchart illustrating a procedure for providing image data. First, a user at one of the user terminals 102-104 uses a web browser supported on the computer assigned with an IP address. The user types in, or selects on the screen, a URI (Uniform Resource Identifier) of a web site providing image services. The URI is usually the top page of the site. In more detail, the user may use the keyboard attached to the one of the user terminals 102-104 to type in the URI on a designated area on the web browser's screen, or use a mouse to select a link to the URI displayed on the web browser's screen. In response to these operations, the web browser sends a request for HTML data related to the image services to the web server 200 via the Internet 100. At the same time, the web browser sends to the web server 200 the assigned IP address of the user terminal and information about the web browser at the user terminal.

When receiving the request for the HTML data from the one of the user terminals 102-104, the web server 200 sends data about a screen for image search provided by the image services back to the one of the user terminals 102-104 at Step S10. The data sent by the web server 200 includes HTML data for providing a user interface of the image services and other relevant data such as image data specified by a design of the screen. The web server 200 also sends to the user information obtaining section 2, information which is not directly relevant to the image services, such as the time and date of the request, or the assigned IP addresses of the user terminals 102-104.

The web browser on the one of the user terminals 102-104 displays the screen for image search provided by the image services, after receiving and interpreting the HTML data from the web server 200. The user inputs keywords of images the user would like to view. The input may be done with the keyboard or the like into a predetermined input area on the screen for the image search. Or, if links pointing to relevant keywords are displayed on the web browser, mouse operations, such as moving and clicking of the mouse on the links, may be used to specify the keywords. After specifying the keywords and other search conditions, the image search is executed at Step S11.

Upon the execution of the image search at the one of the user terminals 102-104, the web server 200 sends information related to the search conditions including the specified keywords to the image database 201. The web server 200 sends information other than the image search conditions which is not directly relevant to the image services, for example, the assigned IP addresses of the user terminals 102-104 which is sent by the web browser when executing the search, or the time and date of the request. The image database 201 searches for images which satisfy the received search conditions such as categories tagged to the image data, shooting date and time, file size, etc., then sends the satisfying images to the image correcting section 3.

The user information obtaining section 2 obtains user information other than the search conditions from the web server 200, which may include, for example, operation time of the user, administrative information including an administrative contact for the IP address assigned to the one of the user terminals 102-104, and the type and version of the OS and the web browser used at the one of the user terminals 102-104.

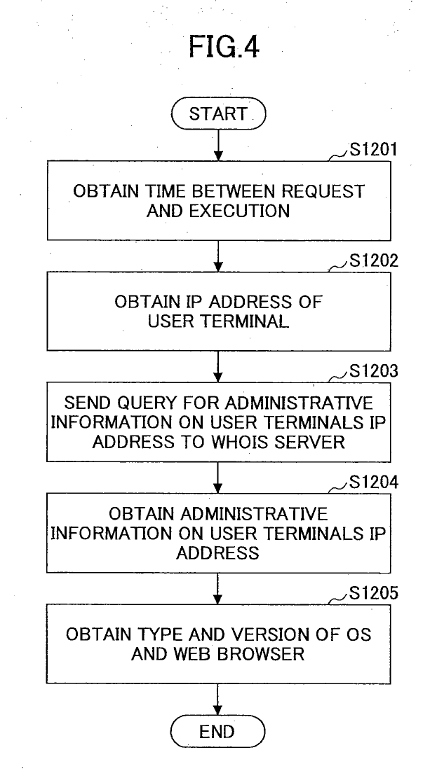

FIG. 4 is a flowchart illustrating a procedure for obtaining user information. First, the data about the operation time of the user is obtained at Step S1201 as the time difference between the time when the request for the image services from the one of the user terminals 102-104 was initiated, and the time when the execution of the search was completed. Administrative information on the IP address is obtained by querying the Whois server 7. The query is sent with the IP address stored in one of the environment variables sent from the web browser to the web server 200, called “REMOTE_ADDR”. The IP address is obtained at Step S1202, and sent for the query at Step S1203. The administrative information is sent back from the Whios server 7 at Step S1204. Information about the type and version of the OS and web browser is obtained from one of the environment variables sent from the web browser to the web server 200, called “HTTP_USER_AGENT”, at Step S1205. The user information obtained as above is sent from the user information obtaining section 2 to the user characteristics predicting section 4.

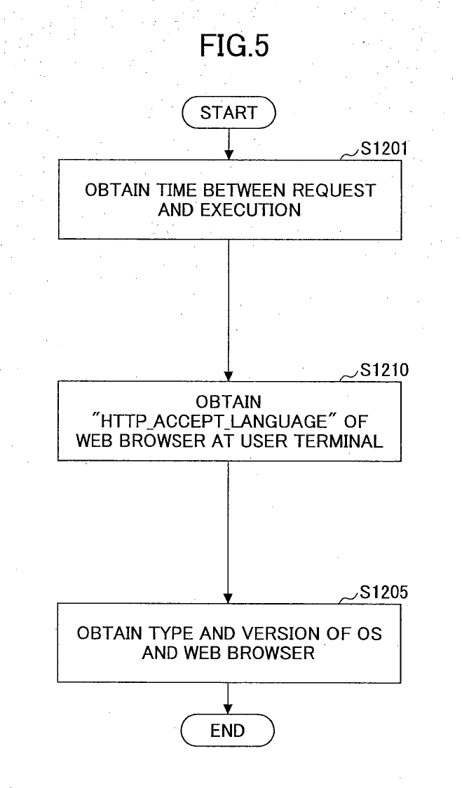

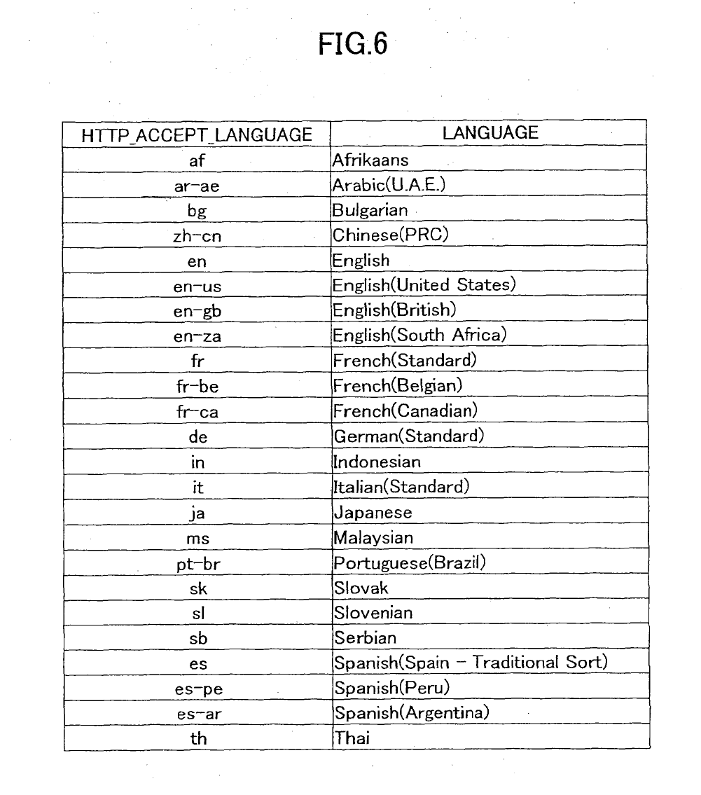

FIG. 5 is another flowchart illustrating a procedure for obtaining user information, in which data on residential regions of the one of the user terminals 102-104 is obtained without querying the Whois server 7. First, the data about the operation time of the user is obtained at Step S1201 as done in FIG. 4. Next, data is obtained from one of the environment variables sent from the web browser to the web server 200, called “HTTP_ACCEPT_LANGUAGE”, at Step S1210. FIG. 6 is a table illustrating correspondences between “HTTP_ACCEPT_LANGUAGE” data and languages. Once a language is identified by referring to the table shown in FIG. 6, it may be possible to predict a corresponding residential region. The processing flow illustrated with FIG. 4 makes inquiries to the Whois server 7 about the administrative information of the IP addresses. A single Whois server 7 may not hold information about all relevant IP addresses. In that case, it is necessary to query multiple Whois servers 7 to identify residential regions corresponding to the one of the user terminals 102-104. Therefore, network traffic may increase with frequent queries. With the processing flow illustrated with FIG. 5, network traffic does not increase because queries to the Whois server 7 are not needed.

Then, information about the type and version of the OS and web browser is obtained as done at Step S1205 in FIG. 4, and the obtained user information is sent to the user characteristics predicting section 4.

Next, as illustrated in FIG. 3, the user characteristics predicting section 4 predicts user characteristics at Step S13. The prediction is based on, as illustrated in FIG. 4, the user's operation time, the type and version of the OS and web browser, and the administrative information of the user terminals 102-104 IP addresses sent from the user information obtaining section 2. The information to be predicted includes the user's age group, compliance with a color management system (CMS) by the OS and web browser used at the user's terminal, and the user's residential region.

As for the user's age group, an evaluation experiment is done beforehand. Based on the evaluation results, ranges of the average operation time for age groups are predetermined statistically, and preserved for later use. The predetermined age groups and operation times, for example, may be set as follow: 0 to 15 s for the age under 29, 15 to 30 s for the age 30 to 49, and 30 s for the age 50 or over. Then, the user's age group is predicted based on an actual operation time of the user. For example, if the operation time of the user is 17 s, the user's age group is predicted to be in the range of 30 to 49.

As for compliance with CMS by the OS used at the user's terminal, types and versions of OSs and their compliance with CMS are checked and recorded beforehand. Then, based on the actual type and version of the OS, the compliance with CMS by the OS is checked. If there is a match on the type of the OS, but no match on the version, it is assumed that the compliance is the same as the compliance of the latest version of the corresponding OS. Similar prediction is done with the web browser to check its compliance with CMS.

As for the user's residential region, a country code corresponding to the administrative information of the IP address is obtained. The country that matches the country code is predicted as the user's residential region. For example, if the residential region is located in Japan, the administrative information of the IP address may include a piece of information such as “*****JP”, where ***** is an arbitrary string. Therefore, a country code such as JP, US, FR, etc., is extracted from the administrative information, and used for the prediction of the user's residential region.

The predicted information obtained by the user characteristics predicting section 4 is sent to the profile selecting section 5. The user characteristics predicting section 4 determines whether the OS is compliant to CMS at Step S14. If the determination result is “YES” at Step S14, the web browser's compliance with CMS is determined at Step S15. If the determination result is “YES” at Step S15, a profile is selected at Step S16. Also, the information that both the OS and web browser are compliant with CMS is sent to the image correcting section 3.

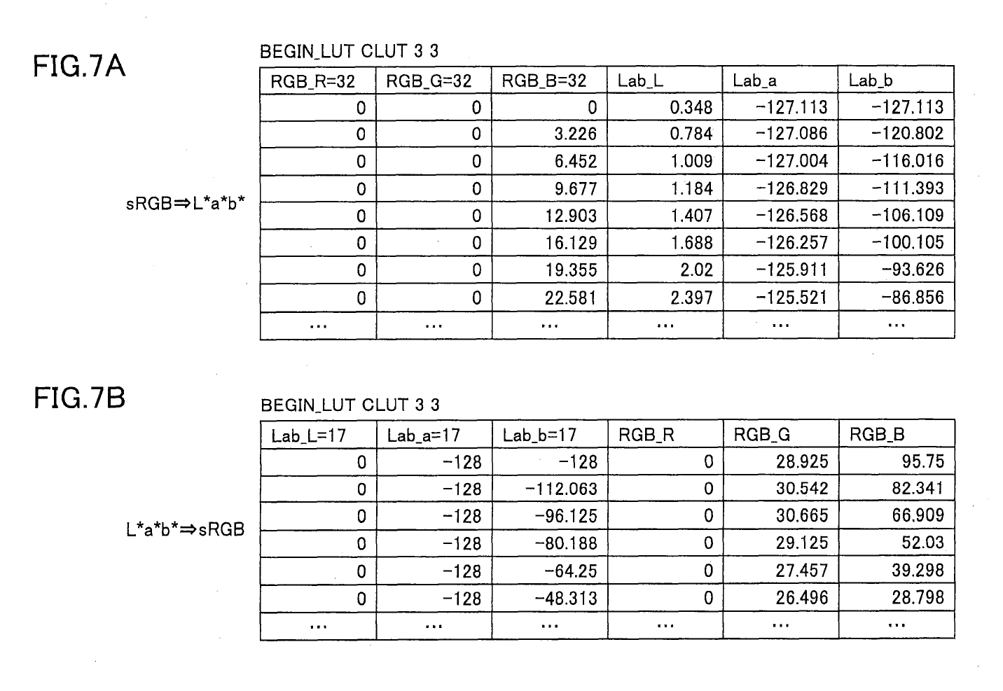

When selecting a profile, a profile corresponding to the predicted information on the user's age group and residential region is read from the profile storing section 6 to send to the image correcting section 3. FIGS. 7A-B are lists illustrating a profile. In the example, FIG. 7A shows a table for converting sRGB (standard RGB) values to L*a*b* values, and FIG. 7B shows a table for converting L*a*b* values to sRGB values. The table in FIG. 7A is generated based on subjective assessment experiments. The table is generated so that sRGB values, which are divided into lattices with equal intervals, correspond to L*a*b* values which reproduce preferred memory colors. The table in FIG. 7B is generated so that L*a*b* values, which are divided into lattices with equal intervals, correspond to sRGB values which give the minimum color differences when paired with lattices.

The image correcting section 3 attaches the profile selected at Step S16 to the satisfying image data from the image database 201 at Step S11, at Step S17. Then, the image correcting section 3 sends the image data attached with the profile to the one of the user terminals 102-104 via the web server 200 and the Internet 100, at Step S20. It is noted that, at Step S17, if the image data includes an AdobeRGB based image (Adobe is a registered trademark of Adobe Systems Incorporated), the image correcting section 3 requests a profile for converting AdobeRGB values to/from L*a*b* values from the profile selecting section 5. The profile selecting section 5 reads a profile about AdobeRGB values corresponding to the user's age group and residential region from the profile storing section 6, then, sends the profile to the image correcting section 3. Then, the image correcting section 3 sends the AdobeRGB based image attached with the profile selected at Step S16 and the profile about AdobeRGB values to the user terminal.

If the determination result is “NO” at Step S14 or Step S15, a profile is selected as done at Step S16. The selected profile is sent to the image correcting section 3. The information that the OS or the web browser is not compliant with CMS is also sent to the image correcting section 3 at Step S18.

The image correcting section 3 corrects the image data based on the profile selected at Step S18, at Step S19. Image correction may be done, for example, using the profile shown in FIGS. 7A-B. In this case, an sRGB based image is converted to an L*a*b* based image with interpolation using the table in FIG. 7A. Then, the converted L*a*b* based image is converted again to another sRGB image using the table in FIG. 7B, which has different sRGB values from the original RGB values of the image stored in the image database 201, but has corrected sRGB values corresponding to the user's age group and residential region. It is noted that, at Step S19, if the image data includes an AdobeRGB based image, the image correcting section 3 requests a profile for converting AdobeRGB values to/from L*a*b* values from the profile selecting section 5. The profile selecting section 5 reads a profile about AdobeRGB values corresponding to the user's age group and residential region from the profile storing section 6, then, sends the profile to the image correcting section 3. The image correcting section 3 converts an AdobeRGB based image to an L*a*b* based image using the received profile, then, corrects the image by converting the L*a*b* based image to another AdobeRGB based image using the profile selected at Step S18. Then, the image correcting section 3 sends the image data attached with the profile to the one of the user terminals 102-104 via the web server 200 and the Internet 100, at Step S20.

When the one of the user terminals 102-104 receives the image processed as above, the one of the user terminals 102-104 whose OS and web browser are compliant with CMS converts the image to a device independent L*a*b* based image using the attached profile; then converts the converted image to an RGB based image using the profile corresponding to the display; and then displays the image on the display. On the other hand, the one of the user terminals 102-104 whose OS or web browser is not compliant with CMS displays the received RGB data whose colors have been corrected as it is. The image has been converted to an sRGB based image, and sRGB is regarded as a standard color format. Therefore, colors of the image may be corrected properly for the one of the user terminals 102-104, which image is displayed on the display.

Further, the present invention is not limited to these embodiments, but various variations and modifications may be made without departing from the scope of the present invention.

The present application is based on Japanese Priority Application No. 2011-265769, filed on Dec. 5, 2011, with the Japanese Patent Office, the entire contents of which are hereby incorporated by reference.

What is claimed is:

1. An image information processing apparatus for processing image information to be provided to user terminals via a communication network, comprising:
a user information obtaining section configured to obtain user information from the user terminals; and
an image correcting section configured to attach a first profile selected based on the user information to the image information to be sent to a first one of the user terminals, the first one of the user terminals being capable of processing the first profile, and to correct colors of the image information according to a second profile selected based on the user information before sending the image information to a second one of the user terminals, the second one of the user terminals being incapable of processing the second profile.

2. The image information processing apparatus as claimed in 1, further comprising:
a user characteristics predicting section configured to generate user characteristics data based on the user information; and
a profile selecting section configured to select the profile corresponding to the user characteristics data from plural of the profiles.

3. The image information processing apparatus as claimed in 1, wherein the user information includes at least IP addresses assigned to the user terminals and information on OSs and web browsers used at the user terminals.

4. The image information processing apparatus as claimed in 1, wherein the user information includes at least language used at the user terminals and information on OSs and web browsers used at the user terminals.

5. The image information processing apparatus as claimed in 1, wherein the user information includes at least IP addresses assigned to the user terminals, languages used at the user terminals, and information on OSs and web browsers used at the user terminals.

6. An image information processing method of processing image information to be provided to user terminals via a communication network, comprising the steps of:
obtaining user information from the information sent from the user terminals;
attaching a first profile selected based on the user information to the image information to be sent to a first one of the user terminals, the first one of the user terminals being capable of processing the first profile; and
correcting colors of the image information according to a second profile selected based on the user information before sending the image information to a second one of the user terminals, the second one of the user terminals being incapable of processing the second profile.

7. The image information processing method as claimed in 6, further comprising the steps of:
generating user characteristics data based on the user information; and
selecting the profile corresponding to the user information from plural of the profiles stored beforehand.

8. A non-transitory computer-readable recording medium having a program stored therein for causing a computer to execute a method of image processing, the method comprising the steps of:
obtaining user information from the information sent from the user terminals;
attaching a first profile selected based on the user information to the image information to be sent to a first one of the user terminals, the first one of the user terminals being capable of processing the first profile; and
correcting colors of the image information according to a second profile selected based on the user information before sending the image information to a second one of the user terminals, the second one of the user terminals being incapable of processing the second profile.
